(19) United States
(12) Patent Application Publication
(10) Pub. No.: US 2007/0132159 A1
(43) Pub. Date: Jun. 14, 2007

(54) Vacuum molding methods and apparatus for manufacturing molded article

(76) Inventors: Takashi Yoshitake, Kariya-shi (JP); Masanobu Kitajima, Kariya-shi (JP); Takao Murase, Kariya-shi (JP)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/634,329

(22) Filed: Dec. 5, 2006

(30) Foreign Application Priority Data
Dec. 12, 2005 (JP) 2005-357584

(51) Int. Cl. B29C 43/10

(52) U.S. Cl. 264/511; 264/571; 425/405.1

(57) ABSTRACT

A vacuum molding method for manufacturing a molded article that has a substrate material and a covering material may includes positioning the substrate material and the covering material between a first molding surface of a first die and a second molding surface of a second die, and closing the first and second dies. The die closing step comprises engaging at least a portion of the periphery of the second die with the first die with interleaving the covering material and the substrate material therebetween.

### BACKGROUND OF THE INVENTION

The present invention relates to vacuum molding methods and apparatus for manufacturing a molded article, e.g., a laminated article that includes a substrate material and a covering material.

A known vacuum molding apparatus (hereinafter simply referred to as a “molding apparatus”) for manufacturing a laminated article is taught by, for example, Japanese Laid-open Patent Publication Number 2005-125735. In this known art, as shown in FIG. 4, the molding apparatus 100 includes a first (lower) die assembly having a first (lower) vacuum molding die 101, and a second (upper) die assembly having a second (upper) vacuum molding die 102 that is formed from a porous material. The first and second die assemblies are arranged and constructed to move toward and away from each other, so that the first and second dies 101 and 102 can be closed and opened. The first die 101 has a convex molding surface 101s, and an annular die closing surface 101f that encircles the molding surface 101s. In addition, the first die 101 is connected to a vacuum source 103. Conversely, the second die 102 has a concave molding surface 102s substantially corresponding to the convex molding surface 101s, and an annular die closing surface 102f that can contact the annular die closing surface 101f when the first and second dies 101 and 102 are closed. In addition, the second die 102 is connected to a vacuum source 105.

In order to manufacture the laminated article, under a condition that the first and second dies 101 and 102 are opened, a substrate material 104 is disposed on the molding surface 101s of the first die 101. The substrate material 104 is previously shaped so as to have a shape corresponding to the shape of the molding surface 101s. Also, the substrate material 104 is previously perforated so as to have air flow paths (not shown) in the thickness direction thereof. Conversely, a covering material 106 is disposed between the first and second dies 101 and 102 so as to be positioned adjacent to the substrate material 104 that is disposed on the molding surface 101s. The covering material 106 is previously softened by heating and is previously applied with an adhesive. Thereafter, the first and second die assemblies are operated, thereby closing the first and second dies 101 and 102. Upon closing of the first and second dies 101 and 102, the covering material 106 is applied to the substrate material 104 while it is shaped by the molding surface 102s of the second die 102. Simultaneously, the periphery of the covering material 106 is clamped between the die closing surfaces 101f and 102f of the first and second dies 101 and 102 along the substrate material 104. As a result, the first and second dies 101 and 102 are sealed along the substrate material 104, so that a hermetic molding cavity is defined therebetween.

Subsequently, the vacuum source 105 of the second die 102 is actuated. As a result, the covering material 106 is drawn toward the molding surface 102s so as to be vacuum molded by the molding surface 102s. Thereafter, the vacuum source 103 of the first die 101 is actuated. As a result, the molded covering material 106 is drawn toward the substrate material 104 disposed on the molding surface 101s via the perforated air flow paths formed in the substrate material 104, so as to be adhered to the substrate material 104. Thus, the laminate article is manufactured.

According to the known molding apparatus, when the first and second dies 101 and 102 is closed, the periphery of the covering material 106 is clamped between the die closing surfaces 101f and 102f of the first and second dies 101 and 102, thereby hermetically sealing the molding cavity positioned between the first and second dies 101 and 102. Therefore, in the known apparatus, in order to seal the molding cavity, the substrate material 104 must be entirely covered with the covering material 106, even if the substrate material 104 should be partly covered with the covering material 106. In such case, in order to manufacture the laminate article in which the substrate material 104 is partly covered with the covering material 106, it is necessary to manufacture the laminated article in which the substrate material 104 is entirely covered with the covering material 106 and then to partly uncover or remove the covering material 106 from the substrate material 104. Therefore, time consuming and labor intensive work is required to manufacture the laminated article. In addition, manufacturing costs of the laminated article are increased.

### BRIEF SUMMARY OF THE INVENTION

It is, accordingly, one object of the present invention to provide improved vacuum molding methods and apparatus for manufacturing a molded article.

In one aspect of the present invention, a vacuum molding method is taught for manufacturing a molded article that has a substrate material and skin material. The method may includes positioning the substrate material and the covering material between a first molding surface of a first die and a second molding surface of a second die, closing the first and second dies, applying a negative pressure to the second molding surface of the second die so that the covering material is drawn toward the second molding die, thereby molding the covering material by the second molding surface, and applying a negative pressure to the first molding surface of the first die so that the covering material is drawn toward the first molding die, thereby adhering the covering material to the substrate material on the first die. The die closing step comprises engaging at least a portion of the periphery of the second die with the first die with interleaving the covering material and the substrate material therebetween.

In another aspect of the present invention, a vacuum molding apparatus is taught for manufacturing a molded article that has a substrate material and a covering material. The apparatus may include a first die having a first molding surface that is arranged and constructed to receive the substrate material, a first vacuum source arranged and constructed to apply a negative force to the first molding surface, a second die having a second molding surface that is arranged and constructed to shape the covering material, and a second vacuum source arranged and constructed to apply a negative force to the second molding surface. At least a portion of the periphery of the second die is arranged and constructed to engage the first die with interleaving the covering material and the substrate material therebetween.

According to the present method and apparatus, in order to form a hermetic molding cavity between the first and second molding surfaces of the first and second dies when the first and second dies are closed, the at least a portion of the second die can urge the first die while the covering material and the substrate material are clamped therebetween. Therefore, a portion of the substrate material that is not intended to be applied with the covering material can be positioned outside the molding cavity. As a result, the covering material can be adhered to only a necessary portion of the substrate material. Therefore, it is possible to manufacture the molded article in which only a necessary portion of the substrate material is covered with the covering material. That is, it is not necessary to partly remove the covering material from the substrate material. As a result, the usage of the covering material can be reduced. This may lead to a reduced manufacturing cost.

Other objects, features and advantage of the present invention will be ready understood after reading the following detailed description together with the accompanying drawings and the claims.

### BRIEF DESCRIPTION OF THE SEVERAL VIEWS OF THE DRAWINGS

FIG. 1(A) is a sectional view of a vacuum molding apparatus for manufacturing a molded article according to a representative embodiment of the present invention, illustrating a condition in which upper and lower dies are closed;

FIG. 1(B) is an enlarged view of an encircled portion B of FIG. 1(A);

FIG. 2 is a sectional view of the vacuum molding apparatus, illustrating a condition in which the upper and lower dies are opened;

FIG. 3(A) is a plan view of the lower die in FIG. 2;

FIG. 3(B) is a cross-sectional view taken along line III(B)-III(B) in FIG. 1(A); and

FIG. 4 is a sectional view of a conventional vacuum molding apparatus, illustrating a condition in which upper and lower dies are opened.

### DETAILED DESCRIPTION OF THE INVENTION

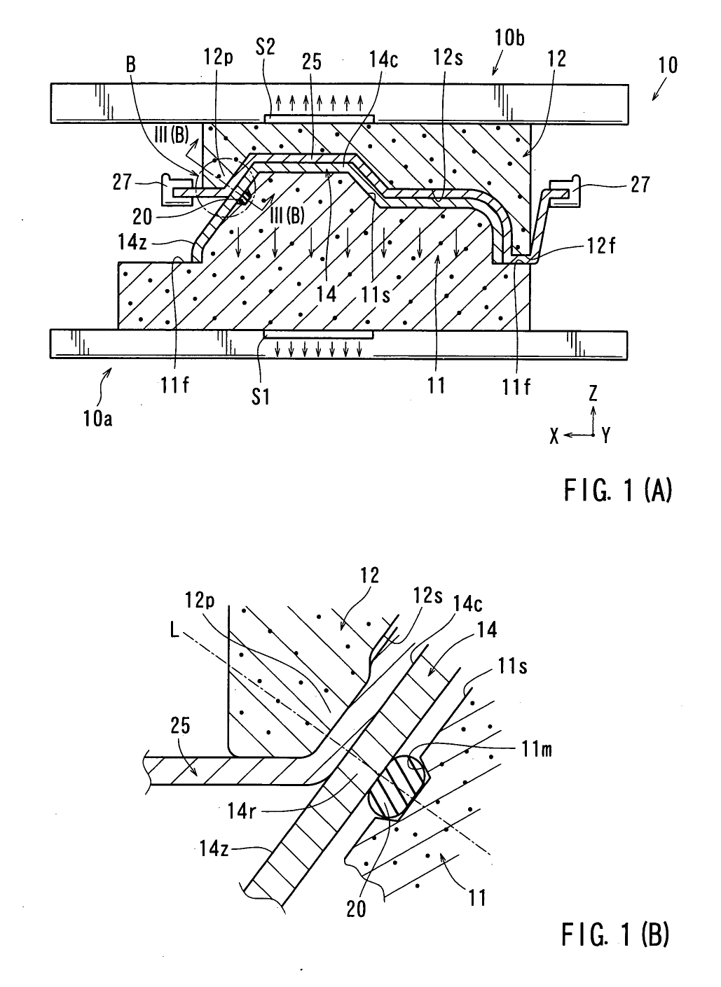

A preferred representative embodiment of the present invention is shown in FIGS. 1(A) to 3(B) in order to produce a molded article, in which a laminated instrument panel is exemplified as the molded article that can be prepared utilizing the present invention. The laminated instrument panel has a substrate material 14 and a covering material 25. Further, in the drawings, the directions shown by references X, Y and Z respectively correspond to “a lateral direction,” “a longitudinal direction” and “a vertical direction.”

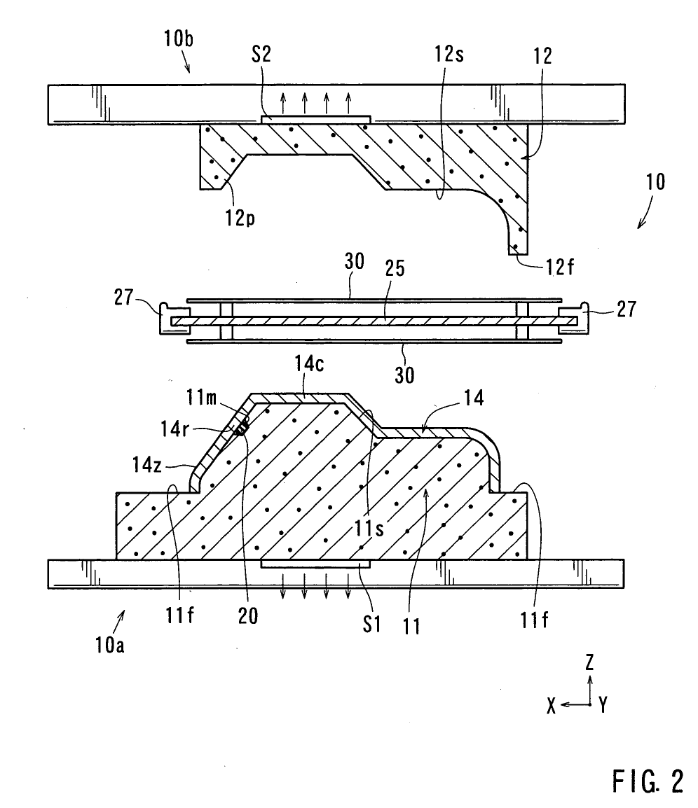

As best shown in FIGS. 1 and 2, a vacuum molding apparatus 10 for manufacturing the laminated instrument panel may include a first (lower) die assembly 10a having a first (lower) vacuum molding die 11 that is formed from a porous material (i.e., air permeable material), and a second (upper) die assembly 10b having a second (upper) vacuum molding die 12 that is formed from a porous material (i.e., air permeable material). The first and second die assemblies 10a and 10b are arranged and constructed to vertically move toward and away from each other, so that the first and second dies 11 and 12 can be closed and opened.

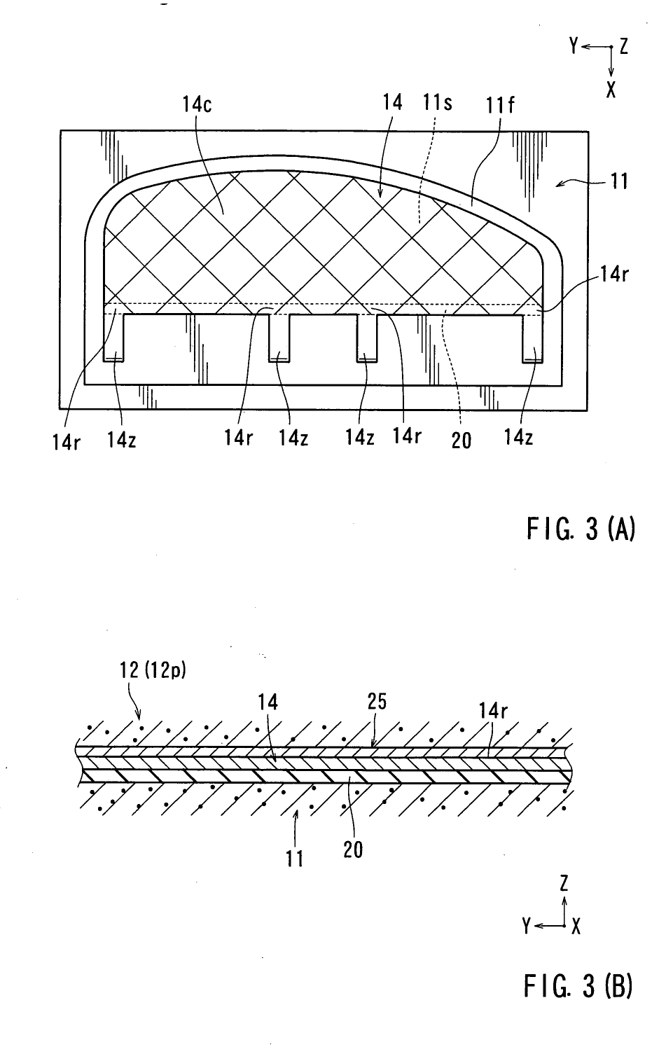

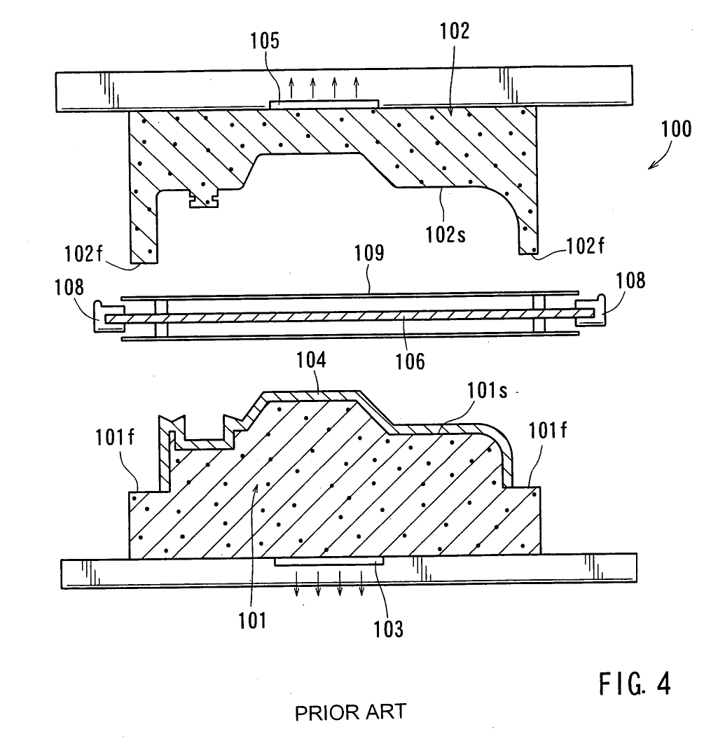

As shown in FIGS. 2 and 3(A), the first die 11 has a convex first molding surface 11s that can support the substrate material 14 thereon, and an annular die closing surface 11f that extends along the periphery of the first die 11. The die closing surface 11f may preferably encircle the first molding surface 11s. Further, the first die 11 is provided with an elongated cylindrical string-like sealing member 20 that extends in the longitudinal direction (the direction Y) along the first molding surface 11s. The sealing member 20 is formed from an elastic material. As best shown in FIG. 1(B), the sealing member 20 may preferably be received in an elongated groove 11m formed in the first die 11, so as to be positioned in place on the first die 11. In addition, the first die 11 is connected to a first vacuum source S1 in order to apply negative pressure to the first molding surface 11s.

Conversely, as shown in FIG. 2, the second die 12 has a concave second molding surface 12s, and a die closing surface 12f that extends along one portion of the periphery of the second die 12. The concave second molding surface 12s substantially corresponds to the convex first molding surface 11s of the first die 11. The die closing surface 12f may partly surround the second molding surface 12s. The die closing surface 12f is arranged and constructed to partly surround the periphery of the first molding surface 11s when the first and second dies 11 and 12 are closed. Also, the die closing surface 12f is arranged and constructed to face a substantial portion of the annular die closing surface 11f when the first and second dies 11 and 12 are closed. Further, the second die 12 has a pressure applying edge 12p that extends along the other portion of the periphery of the second die 12. The pressure applying edge 12p may partly surround the second molding surface 12s and having a width of about 10 mm. The pressure applying edge 12p may preferably be continuous to the die closing surface 12f, so that the second molding surface 12s is encircled by the die closing surface 12f and the pressure applying edge 12p. The pressure applying edge 12p is formed so as to correspond to the sealing member 20 disposed on the first die 11 when the first and second dies 11 and 12 are closed. In addition, similar to the first die 11, the second die 12 is connected to a second vacuum source S2 in order to apply negative pressure to the second molding surface 12s.

As shown in FIG. 2, the vacuum molding apparatus 10 may further include a clamping device 27. The clamping device 27 is arranged and constructed to clamp the periphery of the covering material 25 that is formed as a sheet-shaped member. The clamping device 27 can be moved such that the covering material 25 can be horizontally supported between the first and second dies 11 and 12 when the first and second dies 11 and 12 are opened.

As shown in FIG. 2, the vacuum molding apparatus 10 may further include a heating device 30. The heating device 30 is arranged and constructed such that the covering material 25 supported by the clamping device 27 can be heated at both surfaces so as to be softened. The heating device 30 can be horizontally moved between a heating position shown in FIG. 2 and a retracted position (not shown). As will be appreciated, in the retracted position, the heating device 30 does not interfere with the first and second dies 11 and 12 even if the first and second dies 11 and 12 are moved from a opening position shown in FIG. 2 to a closing position shown in FIG. 1.

Further, the substrate material 14 is previously shaped so as to correspond to the shape of the first molding surface 11s. The substrate material 14 may preferably be formed by injection molding a synthetic resin, e.g., polypropylene (PP). Also, the substrate material 14 is previously perforated so as to have a plurality of air flow paths (not shown) extending in the thickness direction thereof. As best shown in FIG. 3, the substrate material 14 may include a covered portion 14c (an area shown by cross-hatching) that should be covered by the covering material 25, and a exposed or exposed portion 14z that should be left uncovered. The covered portion 14c may have an elongated pressed portion 14r that can be pressed by the pressure applying edge 12p of the second die 12. The pressed portion 14r is positioned adjacent to the exposed portion 14z and having a width of about 10 mm. As will be recognized, the pressed portion 14r is also positioned so as to correspond to the sealing member 20 disposed on the first die 11. As a result, as shown in FIG. 1(B), when the first and second dies 11 and 12 are closed, the pressed portion 14r may preferably be substantially aligned with the pressure applying edge 12p of the second die 12 and the sealing member 20 along a line L.

Conversely, the covering material 25 may preferably be formed as a laminate sheet having an upper or skin layer and a lower or foamed layer (not shown) that are adjoined with each other. The skin layer may preferably be formed as a thin film of a thermoplastic resin, e.g., a thermoplastic olefin (TPO). Conversely, the foamed layer may preferably be formed as a thin foamed film of a foamed resin, e.g., a foamed polypropylene (PP). The laminate sheet may further have an adhesive that is applied to the foamed layer (the foamed film). An example of the adhesive may be a hot-melt olefin adhesive.

A representative method for manufacturing the laminated instrument panel using the vacuum molding apparatus 10 will now be described. First, as shown in FIG. 2, under a condition that the first and second dies 11 and 12 are opened, the pre-shaped substrate material 14 is disposed on the first molding surface 11s of the first die 11.

Thereafter, the covering material 25 having a desired shape and size is attached to the clamping device 27. The clamping device 27 is then moved, so that the covering material 25 is horizontally positioned between the opened first and second dies 11 and 12 while the foamed layer of the covering material 25 faces the substrate material 14 disposed on the first die 11.

Subsequently, the heating device 30 is horizontally moved from the retracted position to the heating position, so that the covering material 25 supported by the clamping device 27 is heated at both surfaces. When the covering material 25 is softened by heating, the heating device 30 is returned to the retracted position.

Next, the first die assembly 10a is operated, so that the first die 11 is moved upwardly to a predetermined elevated position until the covering material 25 supported by the clamping device 27 is overlaid the substrate material 14 disposed on the first die 11. Thereafter, the second die assembly 10b is operated, so that the second die 12 is moved downwardly until the first and second dies 11 and 12 are closed (FIG. 1(A)).

Upon closing of the first and second dies 11 and 12, as shown in FIG. 1(A), the covering material 25 is applied to the substrate material 14 (the covered portion 14c) disposed on the first die 11 while it is shaped by the second molding surface 12s of the second die 12. At this time, the die closing surface 12f of the second die 12 urges or engages the die closing surface 11f of the first die 11 with interleaving the covering material 25 therebetween. That is, the covering material 25 is securely clamped between the die closing surfaces 11f and 12f of the first and second dies 11 and 12 along the periphery of the covered portion 14c of the substrate material 14. As a result, the closed first and second dies 11 and 12 are reliably sealed along a substantial portion of the periphery of the covered portion 14c of the substrate material 14.

Conversely, at this time, the pressure applying edge 12p of the second die 12 urges or engages the first die 11 (the sealing member 20 disposed on the first die 11) with interleaving both of the covering material 25 and the pressed portion 14r of the substrate material 14 therebetween (FIG. 1(B)). That is, the covering material 25 is securely clamped between the pressure applying edge 12p of the second die 12 and the pressed portion 14r of the substrate material 14 while the pressed portion 14r of the substrate material 14 is pressed to the first die 11 via the sealing member 20. As a result, the closed first and second dies 11 and 12 are reliably sealed along a remaining portion of the periphery of the covered portion 14c of the substrate material 14.

Thus, the closed first and second dies 11 and 12 are annularly sealed along the periphery of the covered portion 14c of the substrate material 14, so that a hermetic molding cavity is defined between the molding surfaces 11s and 12s of the closed first and second dies 11 and 12. As will be appreciated, the formed hermetic molding cavity may contain the covered portion 14c of the substrate material 14 and the covering material 25 applied thereon. In other words, the exposed portion 14z of the substrate material 14 that is not intended to be applied with the covering material 25 is positioned outside the molding cavity.

Subsequently, the second vacuum source S2 of the second die 12 is actuated, so that the negative pressure is applied to the second molding surface 12s. As a result, the covering material 25 is drawn toward the second molding surface 12s so as to be molded by the second molding surface 12s. The drawn covering material 25 (the skin layer of the covering material 25) may preferably be embossed with a decorative pattern corresponding to a pattern (not shown) of the second molding surface 12s. Upon completion of the embossing operation, the second vacuum source S2 of the second die 12 is deactuated. After the second vacuum source S2 of the second die 12 is deactuated, the first vacuum source S1 of the first die 11 is actuated, so that the negative pressure is applied to the first molding surface 11s. As a result, the covering material 25 is drawn toward the covered portion 14c of the substrate material 14 because the substrate material 14 is formed with the air flow paths extending in the thickness direction thereof. The drawn covering material 25 (the foamed layer of the covering material 25) may preferably be adhered to the covered portion 14c of the substrate material 14 via the adhesive (the hot-melt adhesive) applied to the foamed layer of the covering material 25. Thus, the laminated instrument panel is vacuum molded within the hermetic molding cavity of the first and second dies 11 and 12. Thereafter, the first and second dies 11 and 12 are opened in order to remove the formed laminated instrument panel therefrom. The removed laminated instrument panel may preferably be finished by trimming or other such processing.

According to the present method, when the first and second dies 11 and 12 are closed, the covering material 25 and the pressed portion 14r of the substrate material 14 can be clamped between the pressure applying edge 12p of the second die 12 and the sealing member 20 disposed on the first die 11, so that the closed first and second dies 11 and 12 can be sealed along a portion of the periphery of the covered portion 14c of the substrate material 14. Therefore, the exposed portion 14z of the substrate material 14 that is not intended to be applied with the covering material 25 can be positioned outside the molding cavity. As a result, the covering material 25 can be adhered to only the covered portion 14c of the substrate material 14. That is, the exposed portion 14z can be left uncovered during the vacuum molding. Therefore, it is possible to manufacture the laminated instrument panel in which only a necessary portion of the substrate material 14 is covered with the covering material 25. As a result, the usage of the covering material 25 can be reduced. This may lead to a reduced manufacturing cost.

The sealing member 20 may effectively increase sealing performance between the first and second dies 11 and 12. Also, the sealing member 20 may reduce rattling produced between the first and second dies 11 and 12. In addition, the present method may contribute to downsizing of the vacuum molding apparatus 10.

Although the second die 12 has the die closing surface 12f and the pressure applying edge 12p in the representative embodiment, the second die 12 may have only the pressure applying edge 12p, if necessary. That is, the pressure applying edge 12p may extend along the entire portion of the periphery of the second die 12, so as to encircle the second molding surface 12s. In such a case, the sealing member 20 may preferably be configured so as to correspond to the pressure applying edge 12p when the first and second dies 11 and 12 are closed. For example, the sealing member 20 may be formed so as to have a frame or ring shape. According to the modified embodiment, it is possible to manufacture a laminated instrument panel in which only the central portion of the substrate material 14 is covered with the covering material 25 (i.e., in which the peripheral portion of the substrate material 14 is not covered with the covering material 25).

The adhesive is applied to the covering material 25 in the representative embodiment. However, the adhesive can instead be applied to the substrate material 14.

The string-like sealing member 20 has a cylindrical shape in cross section in the representative embodiment. However, the sealing member 20 may have various cross-sectional shapes, e.g., an oval shape and a polygonal shape.

Further, in the representative embodiment, the first vacuum source S1 of the first die 11 is actuated after the second vacuum source S2 of the second die 12 is deactuated. However, the first vacuum source S1 of the first die 11 can be actuated while the second vacuum source S2 of the second die 12 is still being actuated.

A representative example of the present invention has been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

What is claimed is:

1. A vacuum molding method for manufacturing a molded article that comprises a substrate material and a covering material, comprising:
positioning the substrate material and the covering material between a first molding surface of a first die and a second molding surface of a second die;
closing the first and second dies;
applying a negative pressure to the second molding surface of the second die so that the covering material is drawn toward the second molding die, thereby molding the covering material by the second molding surface; and
applying a negative pressure to the first molding surface of the first die so that the covering material is drawn toward the first molding die, thereby adhering the covering material to the substrate material on the first die,
wherein the die closing step comprises engaging at least a portion of the periphery of the second die with the first die with interleaving the covering material and the substrate material therebetween.

2. The method as defined in claim 1 further comprising disposing a sealing member on the first die, wherein the sealing member is disposed so as to extend along the at least a portion of the periphery of the second die when the first and second dies are closed.

3. The method as defined in claim 1, wherein the die closing step further comprises engaging a portion of the periphery of the second die with the first die with interleaving only the covering material therebetween.

4. The method as defined in claim 1, wherein the at least a portion of the periphery of the second die is the entire portion thereof.

5. A vacuum molding apparatus for manufacturing a molded article that comprises a substrate material and a covering material, comprising:
a first die having a first molding surface that is arranged and constructed to receive the substrate material;
a first vacuum source arranged and constructed to apply a negative force to the first molding surface;
a second die having a second molding surface that is arranged and constructed to shape the covering material; and
a second vacuum source arranged and constructed to apply a negative force to the second molding surface,
wherein at least a portion of the periphery of the second die is arranged and constructed to engage the first die with interleaving the covering material and the substrate material therebetween.

6. The apparatus as defined in claim 5, wherein the first die comprises a sealing member that is disposed so as to extend along the at least a portion of the periphery of the second die when the first and second dies are closed.

7. The apparatus as defined in claim 6, wherein the sealing member is formed from an elastic material and having an elongated cylindrical shape, and wherein the sealing member is disposed within an elongated groove formed in the first die.

8. The apparatus as defined in claim 5, wherein a portion of the periphery of the second die is arranged and constructed to engage the first die with interleaving only the covering material therebetween when the first and second dies are closed.

9. The method as defined in claim 5, wherein the at least a portion of the periphery of the second die is the entire portion thereof.

10. The apparatus as defined in claim 5, wherein the at least a portion of the periphery of the second die has a width of about 10 mm, so that the substrate material has a pressed portion having a width of about 10 mm.
